(19) United States
(12) Patent Application Publication
(10) Pub. No.: US 2026/0094524 A1
(43) Pub. Date: Apr. 2, 2026

(54) NAVIGATION METHOD AND DEVICE FOR AN AIRCRAFT, AND ASSOCIATED SYSTEM, AIRCRAFT, COMPUTER PROGRAM AND DATA STORAGE MEDIUM

(71) Applicant: SAFRAN ELECTRONICS & DEFENSE, Paris (FR)

(72) Inventors: Philippe ELIE, Moissy-Cramayel (FR); Raphaël JARRAUD, Moissy-Cramayel (FR); Gregory QUICKE, Moissy-Cramayel (FR); Diane MORCHAIN, Moissy-Cramayel (FR)

(73) Assignee: SAFRAN ELECTRONICS & DEFENSE, Paris (FR)

(21) Appl. No.: 19/110,331

(22) PCT Filed: Sep. 12, 2023
(86) PCT No.: PCT/FR2023/051387

§ 371 Date: Mar. 10, 2025

(30) Foreign Application Priority Data
Sep. 13, 2022 (FR) FR2209163

(51) Int. Cl. G08G 5/54; G01C 21/16; G01C 21/18; G06T 7/73; G08G 5/51

(52) U.S. Cl. CPC G08G 5/54; G01C 21/1656; G01C 21/18; G06T 7/73; G08G 5/51; G06T 2207/10032; G06T 2207/30181

(57) ABSTRACT

A navigation method and device for an aircraft, and associated system, aircraft, computer program and information medium. The proposed method is wherein a navigation module determines navigation data of said aircraft and in that it includes: during a landing phase of said aircraft, a step of determining said first navigation data based on data from an inertial measurement unit and from images captured by said aircraft; and during a taxiing phase, a step of determining said first navigation data based on data from the inertial measurement unit and from an odometer.

### TECHNICAL FIELD

This invention relates to the fields of navigation and positioning. More specifically, this invention relates to a navigation method and device for an aircraft, and associated system, aircraft, computer program and information medium. This invention has a particularly advantageous, though in no way limiting, application for the implementation of aircraft navigation systems.

### PRIOR ART

Today, in the prior art, different navigation systems for aircraft exist. In particular, it is known to use, on board an aircraft, an inertial system as a navigation system. More generally, “inertial navigation” will hereinafter refer to a navigation solution exploiting data from an inertial measurement unit (i.e. specific force and angular velocity). The exploitation of inertial data to implement a navigation solution does however presuppose the well-known problem of drift over time of the inertial navigation. Specifically, small measurement errors on the specific force and on the angular velocity are integrated over time by the inertial navigation and thus lead to increasingly large errors in velocity and position.

To limit the drift of an inertial navigation, one approach of the prior art consists in combining inertial data with data from a satellite positioning module, such as a GPS (Global Positioning System) module. In general, a navigation solution combining data from several sensors is described as a “hybrid navigation” solution. Existing inertia-GPS hybrid navigation solutions do however have the following drawbacks. Firstly, a GPS module can be easily scrambled and thus encounter a loss of availability. Moreover, a GPS module is, when close to the ground, subject to interference due to multiple path propagation, which causes a loss of accuracy of the satellite positioning. Ultimately, inertia-GPS hybrid navigation solutions do not allow to reliably and accurately locate an aircraft during the landing phase.

In the prior art, the navigation system used to assist aircraft during a landing is the so-called ILS (acronym of Instrument Landing System). The system ILS is a radio navigation system making it possible to provide pilots with items of position and/or orientation information, with respect to the axis of a runway and with respect to the diagonal plane of descent toward the runway. Nonetheless, the system ILS requires specific equipment both on the ground and on board aircraft, particularly antennas on the runway and specific onboard measurement instruments, which leads to a significant complexity of implementation, maintenance, etc.

There is consequently a need for a navigation solution making it possible to accurately locate an aircraft during a landing phase and requiring simple equipment.

### SUMMARY OF THE INVENTION

This invention has the aim of remedying all or part of the drawbacks of the prior art, particularly those set out previously.

For this purpose, according to an aspect of the invention, provision is made for a navigation method for an aircraft, wherein a first navigation module determines first navigation data of said aircraft, said method comprising:
during a landing phase of said aircraft, a step of determining said first navigation data based on data from an inertial measurement unit and from images captured by said aircraft; and
during a taxiing phase following the landing of said aircraft, a step of determining said first navigation data based on data from the inertial measurement unit and from at least one odometer.

Said first navigation data determined during the taxiing phase are function of said first navigation data determined during the landing phase.

The term “navigation data” here refers to: data relating to the position, and/or the displacement of the aircraft, such as geographical coordinates (e.g. latitude, longitude, altitude), a velocity, a heading etc. ; and/or radii of protection associated with position/displacement data. In the context of the invention, a “position” may refer to an absolute position defined with respect to the terrestrial frame of reference, or a relative position defined with respect to a reference position (e.g. a runway).

In the context of the invention, the “landing phase” comprises the approach by said aircraft of a runway and the landing of said aircraft on the runway. Also, the “taxiing” phase here refers to all the movements of the aircraft on the ground. The transition from the landing phase to the taxiing phase is detected by a Weight on Wheels switch, this switch indicating whether or not the weight of the aircraft is resting on its wheels.

In the context of the invention, the term “inertial measurement unit” refers to a measuring device providing, for a plurality of measuring times, data relative to the specific force (i.e. the sum of the external forces other than gravitational forces, divided by the mass) and the angular velocity of the aircraft. Furthermore, the term “inertial system” hereinafter refers to a navigation device integrating over time the specific force and angular velocity data produced by an inertial measurement unit and making it possible to determine navigation data of the aircraft.

As mentioned previously, the navigation data determined during the taxiing phase are a function of the navigation data determined during the landing phase. Specifically, this property is the result of the use of data from the inertial measurement unit to obtain the navigation data of the aircraft, which of necessity involves an integration of the inertial data over time. More precisely, the navigation system can continuously integrate the data from the inertial measurement unit over time such that the navigation data determined at one time are used to determine the navigation data at subsequent times. It could also be envisioned, in the scope of the invention, for the navigation system to integrate the inertial data by flight phase and, to initialize the inertial navigation at the start of a phase, to use navigation data determined during the preceding phase.

The proposed method allows to accurately determine the navigation data of an aircraft during the landing and taxiing phases from simple (i.e. non-specific) equipment. Specifically, the synergy between the different sensors used for the navigation (i.e. inertial measurement unit and camera, then inertial measurement unit and wheel odometer) allows to maintain an accurate localization chain during the landing and taxiing phases.

More specifically, the use of images allows to palliate the inertial navigation drift and improve the navigation accuracy during the landing phase. Similarly, the use of data from a wheel odometer allows to palliate the inertial navigation drift and improve the accuracy of navigation during the taxiing phase.

A clarification will now be given as regards the synergy between the steps and the means implemented by the proposed method. An odometer measures a distance travelled and, for this reason, accurately locating the aircraft during the taxiing phase based on odometer data requires an accurate positioning at the time of landing. Also, the localization during the taxiing phase based on an odometer is even more accurate when images are used to improve the localization during the landing phase. In other words, a navigation solution independently combining: firstly, inertial data with images; and secondly, inertial data with odometer data, would be less accurate than the proposed solution.

By comparison with existing solutions, and particularly a navigation system ILS, the proposed method allows, during the landing phase, to locate an aircraft without requiring any complex specific equipment and allows, during the taxiing phase, to more accurately locate the aircraft.

According to an embodiment, a second navigation module determines second navigation data. According to this embodiment, the proposed method comprises, during a flight phase of said aircraft preceding the landing phase, a step of determining said second navigation data based on data from the inertial measurement unit and from a satellite positioning module.

This embodiment allows, owing to the exploitation of a satellite positioning module, to accurately locate the aircraft during the flight phase. In particular, the data of the satellite positioning module are accurate and reliable at altitude during said flight phase and allow to palliate the drift of the inertial navigation.

According to an embodiment, the proposed method comprises, during a phase of descent of said aircraft preceding the landing phase and following the flight phase, a step of determining said first navigation data based on data from the inertial measurement unit and from an altimeter.

On approaching the ground, the satellite positioning module is subject to interference due to multi-path propagation. Thus, by exploiting the inertial measurement unit and an altimeter (and not the satellite positioning module), this embodiment allows to maintain an accurate localization of the aircraft during the descent.

According to an embodiment, a control module provides said navigation data to a guiding module of said aircraft. In particular, during said flight phase, the control module provides to the guiding module said second navigation data determined by the second navigation module; and, during the phases following said flight phase of said aircraft (i.e. during the descent, landing and taxiing phases), the control module provides to the guiding module said first navigation data determined by the first navigation module.

This embodiment allows to accurately guide the aircraft during the different phases of a flight of the aircraft, and particularly during landing and taxiing.

Note that this embodiment benefits from the technical advantages of the embodiments previously described. Specifically, an accurate guiding of the aircraft is made possible because the navigation data of the aircraft are accurately determined during the different phases. In particular, for one of said phases (i.e. flight, descent, landing, and taxiing phases), the control module allows to provide the guiding module with the navigation data produced by the navigation module (i.e. said first or said second module) that are the most accurate during this phase.

According to an embodiment, the proposed method further comprises:
during a first part of the landing phase, a step of determining said first navigation data based on an observed position and on a known position of a single terrestrial reference point detected in said captured images; and
during a second part of the landing phase, a step of determining said first navigation data based on observed positions and on known positions of several terrestrial reference points detected in said captured images.

In the context of the invention, a “terrestrial reference point” is a terrestrial point, the position of which (e.g. the geographical coordinates) is known. Hereinafter, a terrestrial reference point is also referred to by the term “landmark”.

By using a first landmark as soon as it is detected, this embodiment allows to quickly palliate the drift of the inertial navigation. Then, using several landmarks as soon as these latters are detected, this embodiment allows to more accurately palliate the drift of the inertial navigation. Thus, this embodiment allows to improve the accuracy of the navigation data determined during the landing stage.

In combination with the preceding embodiments, the proposed navigation solution allows to associate different forms of navigation hybridization in different phases of a flight of the aircraft (i.e. inertia-GPS, inertia-altimeter, inertia-imaging with a landmark, inertia-imaging with several landmarks, then inertia-odometer). The proposed sequence of these different forms of navigation hybridization allows, to accurately determine the navigation data synergistically. By comparison, a navigation solution implementing these different forms of hybridization independently, for example in separate modules, would be less accurate.

More generally, the proposed solution allows to capitalize on the respective advantages of the different sensors to obtain accurate items of navigation information. For each of the different phases, the proposed solution is based on the data transmitted by sensors that are accurate and reliable during this phase.

According to an embodiment, the proposed method comprises:
a step of detecting at least one terrestrial reference point in said captured images;
a step of determining an observed relative position of said at least one terrestrial reference point detected with respect to said aircraft based on said captured images; and
a step of determining an estimated relative position of said at least one terrestrial reference point detected with respect to said aircraft based on a position of said aircraft determined by the first navigation module and on a known position of said at least one terrestrial point.

According to this embodiment, said first navigation data are determined by the first navigation module based on the difference between the observed and estimated relative positions of said at least one terrestrial reference point with respect to said aircraft.

This embodiment allows to palliate the drift of the inertial navigation based on images captured by the aircraft.

It should also be mentioned that, in the scope of the invention, other embodiments could envisioned in which the navigation data are determined based on captured images, for example using visual odometry techniques, cartographic recalibration techniques, automatic learning algorithms, etc.

According to an embodiment, at least one said navigation module comprises an inertial system and a Kalman filter to determine said navigation data. More specifically, the first navigation module comprises a first inertial system and a first Kalman filter to determine said first navigation data; and the second navigation module comprises a second inertial system and a second Kalman filter to determine said second navigation data.

This embodiment allows to perform a fusion of multi-sensor data to determine navigation data of the aircraft.

In particular, the use of an inertial system allows to determine navigation data based on the inertial data; and the use of a Kalman filter allows to correct these navigation data based on data from the other sensors (i.e. recalibration of the inertial navigation to palliate the drift). Thus, the combination of an inertial system and of a Kalman filter allows to accurately determine the navigation data of the aircraft based on independent sensors and sensors of different types.

According to another aspect of the invention, provision is made for a navigation device for an aircraft comprising a first navigation module configured to determine first navigation data of said aircraft based on data from an inertial measurement unit, from at least one odometer and from images captured by said aircraft.

The proposed navigation device has the advantages described above in relation to the proposed navigation method. According to an embodiment, the navigation device implements all or part of the steps of the proposed navigation method.

According to an embodiment, the navigation device comprises a second navigation module configured to determine second navigation data based on data from the inertial measurement unit and from a satellite positioning module.

According to an aspect of the invention, provision is made for a navigation system for an aircraft comprising: a navigation device in accordance with the invention; an inertial measurement unit; an image capture device; and at least one odometer.

The proposed navigation system has the advantages described above in relation to the proposed navigation method. According to an embodiment, the proposed navigation system implements all or part of the steps of the proposed navigation method.

According to an embodiment, the navigation system comprises a satellite positioning module; and/or an altimeter.

According to an embodiment, the navigation system comprises a computer vision device configured to determine at least one position of the aircraft based on the images captured by said image capture device.

According to an embodiment, the navigation system comprises a guiding module configured to guide said aircraft based on navigation data determined by said navigation device in accordance with the invention.

According to an aspect of the invention, provision is made for an aircraft comprising a navigation system in accordance with the invention.

According to an aspect of the invention, provision is made for a computer program comprising instructions for implementing the steps of a method in accordance with the invention, when the computer program is executed by at least one processor or a computer.

The computer program can be formed of one or more sub-parts stored in one and the same memory or in separate memories. The program can use any programming language, and be in the form of source code, object code, or intermediate code between source code and object code, such as in a partially compiled form, or in any other desirable form.

According to an aspect of the invention, provision is made for an information medium readable by a computer comprising a computer program in accordance with the invention.

The information medium can be any entity or device capable of storing the program. For example, the medium may include a storage means, such as a non-volatile memory or ROM, for example a CD-ROM or a microelectronic circuit ROM, or else a magnetic recording means, for example a diskette or a hard disk. Moreover, the storage medium can be a transmissible medium such as an electrical or optical signal, which can be conveyed via an electrical or optical cable, by radio or by a telecommunication network or by a computer network or by other means. The program according to the invention can in particular be downloaded over a computer network. Alternatively, the information medium can be an integrated circuit into which the program is incorporated, the circuit being suitable for executing or for being used in the execution of the method in question.

### BRIEF DESCRIPTION OF THE DRAWINGS

Other features and advantages of this invention will become apparent from the description provided hereinafter of embodiments of the invention. These embodiments are given by way of illustrative example and are devoid of any limitation. The description provided hereinafter is illustrated by the attached drawings:

FIG. 1 schematically represents an example of software and hardware architecture of a navigation system according to an embodiment of the invention;

FIGS. 2A and 2B represent, schematically and in the form of a flow chart, steps of a navigation method according to an embodiment of the invention; and

FIG. 3 schematically represents an example of software and hardware architecture of a navigation system according to an embodiment of the invention.

### DESCRIPTION OF THE EMBODIMENTS

This invention relates to a navigation method and device for an aircraft, along with associated system, aircraft, computer program and information medium.

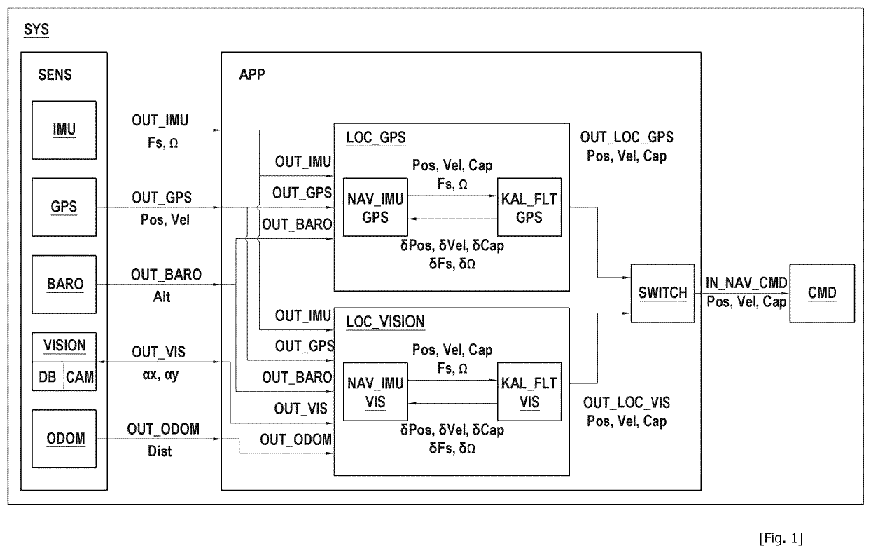

FIG. 1 schematically represents an example of a software and hardware architecture of a navigation system according to an embodiment of the invention.

In the context of the invention, an “aircraft” refers to any device capable of rising up and moving through the air, such as an airplane, a helicopter, a drone etc. According to an embodiment, the navigation system SYS is on board an aircraft AC (seen on 2A).

As illustrated by FIG. 1, according to an embodiment, the navigation system SYS proposed for an aircraft comprises at least one of the following elements: a set of sensors SENS; a navigation device APP; and a guiding module CMD.

The navigation device APP is configured to determine, based on the data from the set of sensors SENS, navigation data IN_NAV_CMD of the aircraft AC.

The guiding module CMD is configured to guide the aircraft AC based on the navigation data IN_NAV_CMD provided by the device APP.

In the context of the invention, the term “navigation data of an aircraft” refers to data relating to the position, and/or to the displacement of the aircraft and comprise, for example, geographical coordinates (e.g. latitude, longitude, altitude), a velocity, or a heading. The navigation data can be defined absolutely with respect to the terrestrial frame of reference, or relatively with respect to a reference position (e.g. a runway). By way of example, a relative position of the aircraft AC at a given time determined by the navigation device APP may comprise one or more coordinates of the following set: an azimuth, a vertical distance, a longitudinal distance, and a lateral distance defined with respect to a reference position.

As illustrated by FIG. 1, according to an embodiment, the set of sensors SENS comprises at least one of the following sensors: at least one inertial measurement unit IMU; at least one satellite positioning module GPS; at least one altimeter BARO; a sensor VISION (hereinafter referred to as a computer vision device or sensor); at least one odometer; a Pitot probe; and a magnetometer.

The inertial measurement unit IMU provides data OUT_IMU, also known as inertial data. According to an embodiment, the inertial data OUT_IMU comprise, for a plurality of measurement times, data relating to the specific force Fs (i.e. the sum of the external forces, other than gravitational forces, divided by the mass) and the angular velocity Ω of the aircraft AC. Typically, the inertial measurement unit IMU comprises: three gyroscopes measuring the three components of the angular velocity Ω (which allow to compute the velocities of variation of the roll, pitch and yaw); and three accelerometers measuring the three components of the specific force Fs.

The satellite positioning module GPS provides navigation data OUT_GPS. According to an embodiment, the navigation data OUT_GPS comprise, for a plurality of measurement times, a position Pos and a velocity Vel of the aircraft AC. Typically, the satellite positioning module GPS provides an absolute position Pos with respect to the terrestrial frame of reference comprising one or more coordinates of the following set: the latitude, the longitude; and the altitude. According to an embodiment, the satellite positioning module is compliant with the Global Positioning System, more commonly referred to by the acronym GPS. However, within the scope of the invention, other embodiments could also be envisioned in which all types of GNSS (Global Navigation Satellite System) modules would be used, such as Galileo, Glonass modules etc.

The altimeter BARO provides as output so-called altimetric data OUT_BARO. The altimeter BARO is, according to an embodiment, a barometric altimeter. In particular, the altimetric data OUT_BARO are, for a plurality of measurement times, representative of the altitude Alt of the aircraft AC or of variations in altitude of said aircraft AC.

The computer vision sensor VISION (also referred to as “computer vision device”) provides as output data OUT_VIS. According to an embodiment, the sensor VISION comprises or is configured to communicate with: a recording medium DB; and an image capture device CAM. The recording medium DB, for example a database, comprises the positions (i.e. geographical coordinates) of a plurality of terrestrial reference points AMER_1-AMER_3 (hereinafter referred to as landmarks) as well as items of information relating to the graphical representations of the terrestrial reference points AMER_1-AMER_3. By way of example, the terrestrial reference points may be a runway, a navigation light, a Precision Approach Path Indicator, etc. The image capture device CAM comprises at least one camera onboard the aircraft AC and possessing a sensor of electromagnetic radiation, the wavelengths of which belong to the spectrum of visible and/or infrared light. According to an embodiment, the image capture device CAM comprises at least one video camera from among the following: a visible-light camera; a near-infrared camera, a short-wavelength infrared camera, a medium-wavelength infrared camera, and a long-wavelength infrared camera. The image capture device CAM is configured to capture a plurality of images for a plurality of measurement times.

The computer vision sensor VISION takes as input: the images captured by the image capture device CAM; and the navigation data OUT_LOC_VIS from the navigation module LOC_VISION, particularly the position of the aircraft AC. The sensor VISION is, according to an embodiment, configured to: detect the terrestrial reference points AMER in the captured images; and to determine the observed relative positions of the detected terrestrial reference points AMER_1-AMER_3 with respect to the aircraft AC based on said captured images. The sensor VISION is moreover configured, according to an embodiment, to determine estimated relative positions of the detected terrestrial reference points AMER_1-AMER_3 with respect to the aircraft AC based on a position of the aircraft AC determined by the navigation module LOC_VISION and on the known positions of the terrestrial reference points AMER_1-AMER_3. According to an embodiment, the data OUT_VIS provided by the sensor VISION comprise, for a plurality of measurement times, differences ax, ay between the observed and estimated relative positions of the terrestrial reference points AMER_1-AMER_3 with respect to the aircraft AC. Typically, the relative position (observed or estimated) of a landmark with respect to the aircraft AC is defined by two angles—a lateral angle and a vertical angle-characterizing the line of sight of the landmark with respect to the longitudinal axis of the aircraft AC.

According to an embodiment, to detect a terrestrial reference point in an image, the sensor VISION is configured to select in this image a region of interest (i.e. in a portion of this image) and detect the terrestrial reference point in this region of interest. In particular, the coordinates of the region of interest are determined based on: the known position of the terrestrial reference point; the position of the aircraft AC determined by the navigation module LOC_VISION; and on an item of information provided by the navigation module LOC_VISION relating to the radius of protection of the determined position of the aircraft AC (i.e. the probability that the position error is less than the radius of protection is greater than a defined value, particularly close to 1). The fact of using a region of interest allows to restrict the image portion to detect a landmark and thus allows to reduce the hardware and software resources (e.g. processing time, memory etc.) needed for the detection of a landmark in captured images as well as the probability of a false detection.

The odometer ODOM produces as output so-called odometer data OUT_ODOM. According to an embodiment, the odometer data OUT_ODOM are, for a plurality of measurement times, representative of a distance Dist travelled by the aircraft AC or one of the wheels of the aircraft AC between at least two measurement times during a taxiing phase. The odometer ODOM determines, according to a variant of the invention, a distance travelled by the aircraft AC between two measurement times based on a number of revolutions made by a wheel of the aircraft AC between these two times and on a radius of this wheel.

According to an embodiment, the set of sensors SENS comprises a plurality of odometers ODOM. This embodiment moreover allows to obtain an item of information as to the direction of the aircraft AC during a taxiing phase.

Of course, the set of sensors SYS may comprise one or more of each of the sensors IMU, GPS, BARO, VISION, and ODOM as described above.

As illustrated by FIG. 1, the navigation device APP comprises, according to an embodiment: a navigation module LOC_ GPS (the so-called second navigation module); a navigation module LOC_VISION (the so-called first navigation module); and a control module SWITCH. The navigation modules LOC_GPS and LOC_VISION respectively provide navigation data OUT_LOC_GPS (the so-called second navigation data) and navigation data OUT_LOC_VIS (the so-called first navigation data). It should be noted that the navigation modules LOC_GPS and LOC_VISION produce navigation data OUT_LOC_GPS and OUT_LOC_VIS independently and, more specifically, simultaneously (i.e. in parallel.) According to an embodiment, the navigation data OUT_LOC_GPS and OUT_LOC_VIS respectively comprise, for a plurality of measurement times, a position Pos, a velocity Vel and a direction Cap of the aircraft AC.

It should be noted that the parallel use of the two separate navigation modules LOC_GPS and LOC_VISION allows to improve the integrity of the navigation system SYS of the aircraft AC and thus the resilience of the system SYS as regards malfunctions of the sensors used for navigation.

The navigation module LOC_GPS determines the navigation data OUT_LOC_GPS based on the data from the inertial measurement unit IMU, the satellite positioning module GPS, and the altimeter BARO.

As illustrated by FIG. 1, according to an embodiment, the navigation module LOC_GPS comprises: an inertial system NAV_IMU_GPS; and a Kalman filter KAL_FLT_GPS. The inertial system NAV_IMU_GPS is configured to integrate over time the specific force Fs and angular velocity Ω data produced by the inertial measurement unit IMU and thus determine navigation data Pos, Vel, and altitudes including the heading Cap of the aircraft AC. The Kalman filter KAL_FILT_GPS determines, based on the data from the sensors GPS and BARO, the corrections δPos, δVel, δCap, δFs, and δΩ to be applied to the inertial system NAV_IMU_GPS. The navigation data OUT_LOC_GPS provided as output thus correspond, according to an embodiment, to the navigation data determined by the inertial system NAV_IMU_GPS corrected (i.e. recalibrated) based on the data from the Kalman filter KAL_FLT_GPS. In other words, the Kalman filter KAL_FLT_GPS allows to offset the inertial navigation drift (i.e. recalibrate) based on the data from the sensors GPS and BARO.

Note that, when the satellite positioning module GPS is not available (e.g. faulty, or unusable), the navigation module LOC_GPS continues to produce as output the navigation data OUT_LOC_GPS. However, in this case, the navigation module LOC_GPS cannot exploit the data from the satellite positioning module GPS to palliate the drift (i.e. recalibrate) of the inertial system NAV_IMU_GPS. The same applies when the altimeter BARO is unavailable

The navigation module LOC_VISION determines the navigation data OUT_LOC_VIS based on the data from the inertial measurement unit IMU, the satellite positioning module GPS, the altimeter BARO, the sensor VISION and the odometer ODOM.

As illustrated by FIG. 1, the navigation module LOC_VISION has, according to an embodiment, a similar architecture to the navigation module LOC_GPS. According to this embodiment, the navigation module LOC_VISION comprises: an inertial system NAV_IMU_VIS; and a Kalman filter KAL_FLT_VIS.

The navigation data OUT_LOC_GPS provided as output thus correspond, according to an embodiment, to the navigation data determined by the inertial system NAV_IMU_VIS to which are applied the corrections determined by the filter KAL_FLT_GPS based on the data from the sensors GPS, BARO, VISION and ODOM. In other words, the Kalman filter KAL_FLT_GPS allows to palliate the inertial navigation drift (i.e. recalibrate) based on the data from the sensors GPS, BARO, VISION and ODOM.

In the scope of the invention, other embodiments could also be envisioned in which one of the navigation modules or both respectively use a Kalman filter taking as input the data from the different sensors including the inertial measurement unit and producing as output said navigation data.

It should be mentioned that the navigation module LOC_VISION exploits, to recalibrate the inertial system NAV_IMU_VIS, the data from the other sensors GPS, BARO, VISION and ODOM when these data are available. According to an example, when the aircraft AC is in flight, the odometer ODOM is not available and cannot be used by the navigation module LOC_VISION to recalibrate the inertial system NAV_IMU_VIS. Similarly, the navigation module LOC_VISION does not exploit the data from the satellite positioning module GPS, when the module GPS is malfunctioning or unusable.

However, it is important to emphasize that the navigation data determined at a given time are a function of the navigation data determined at the preceding times.

Specifically, the inertial systems NAV_IMU_GPS and NAV_IMU_VIS integrate over time the specific force Fs and angular velocity Q data produced by the inertial measurement unit IMU to determine navigation data OUT_LOC_GPS and OUT_LOC_VIS. Also, small errors of measurement of the specific force Fs and of the angular velocity Q are integrated over time by the inertial systems and thus lead to velocity and position errors that increase over time (i.e. inertial navigation drift). Consequently, the fact of using, at a given time, a sensor to recalibrate an inertial system allows to improve the accuracy of the navigation data determined at the subsequent times.

Suppose for example that during a first flight phase of the aircraft AC, the navigation module LOC_VISION uses the data of the module GPS to recalibrate the position first and offset the drift of the inertial system NAV_IMU_VIS. Then, during a second later flight phase, the satellite positioning module GPS is no longer available. During the second phase, although the module GPS is no longer available, the navigation module LOC_VISION determines more accurate navigation data OUT_LOC_VIS than a navigation module that never exploits the data of a module GPS. This is because the navigation module LOC_VISION benefits during the second flight phase from the recalibration of the inertial system during the first flight phase.

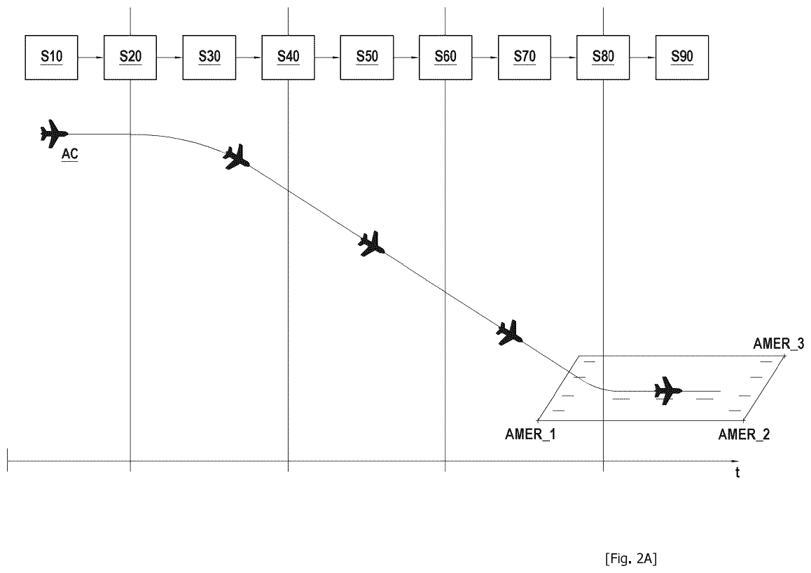

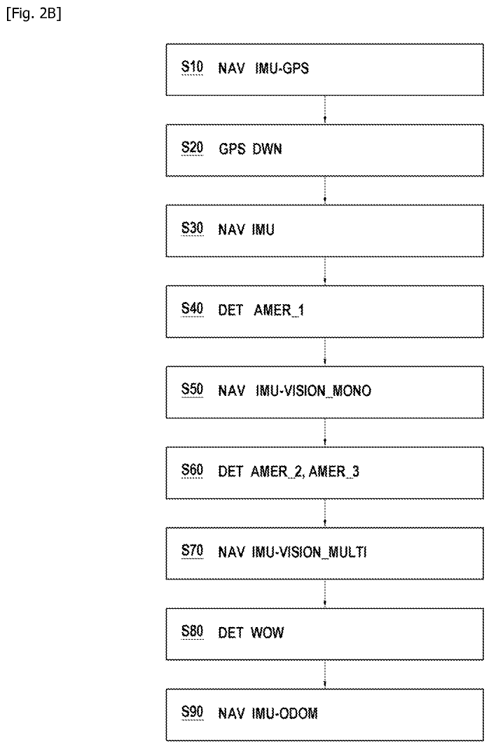

The control module SWITCH receives the navigation data OUT_LOC_GPS and OUT_LOC_VIS respectively produced by the navigation modules LOC_GPS and LOC_VISION and provides to the guiding module CMD the navigation data IN_NAV_CMD. According to an embodiment, the control module SWITCH provides the guiding module CMD with either the navigation data OUT_LOC_GPS, or the navigation data OUT_LOC_VIS. In particular, the control module SWITCH is configured to select the navigation data to be provided as a function of the different phases of a flight of the aircraft, this embodiment being detailed hereinafter with reference to FIGS. 2A and 2B. More specifically, the control module SWITCH is configured to select the navigation data to be supplied as a function of the availability of the satellite positioning module GPS: if, and only if, the satellite positioning module GPS is available, the navigation data OUT_LOC_GPS are provided to the guiding module CMD; otherwise (the module GPS being unavailable, malfunctioning or unusable), the navigation data OUT_LOC_VIS are provided to the guiding module CMD.

Nonetheless, in the scope of the invention, other embodiments could be envisioned according to which the navigation module LOC_GPS or the navigation module LOC_VISION is enabled as a function of the different flight phases of the aircraft AC and provides navigation data to the guiding module CMD. For example, when the module GPS is usable, the navigation module LOC_GPS is enabled and provides to the guiding module CMD the navigation data OUT_LOC_GPS; and, otherwise, when the module GPS is not usable, the navigation module LOC_VISION is enabled and provides to the guiding module CMD the navigation data OUT_LOC_VIS.

FIGS. 2A and 2B show, schematically and in the form of a flow chart, steps of a navigation method according to an embodiment of the invention.

As illustrated by FIGS. 2A and 2B, and according to an embodiment of the invention, the navigation method comprises at least one of the following steps S10 to S50 implemented by the navigation system SYS. According to a particular embodiment, the steps S10 to S50 are implemented in a chronological order as described hereinafter.

During a flight phase of the aircraft AC, the navigation system SYS implements the step S10.

During the step S10, the navigation modules LOC_GPS and LOC_VISION respectively determine navigation data OUT_LOC_GPS and OUT_LOC_VIS based on data from the inertial measurement unit IMU and from the satellite positioning module GPS; the control module SWITCH provides to the guiding module CMD the navigation data OUT_LOC_GPS determined by the navigation module LOC_GPS. Thus, during this flight phase, the inertial navigation is recalibrated with the data from the satellite positioning module GPS.

During the step S20, the navigation device APP disables the use of data OUT_GPS from the satellite positioning module GPS. Thus, following the step S20, and for all the phases and steps described hereinafter, the navigation module LOC_GPS and LOC_VISION no longer exploit the data from the module GPS; also, the control module SWITCH provides to the guiding module CMD exclusively the navigation data OUT_LOC_VIS determined by the navigation module LOC_VISION. According to a particular embodiment, the navigation device APP disables the use of the data OUT_GPS from the satellite positioning module GPS following the receipt, from a command module, of an instruction to no longer use the satellite positioning module GPS.

During a so-called phase of descent of the aircraft AC, following the step S20, the navigation system SYS implements the step S30.

During the step S30, the navigation module LOC_VISION determines navigation data OUT_LOC_VIS based on data from the inertial measurement unit IMU. According to an embodiment, the navigation module LOC_VISION determines navigation data OUT_LOC_VIS moreover based on data from the altimeter BARO.

During the step S40, the computer vision sensor VISION detects a terrestrial reference point AMER_1 (e.g. the runway) in images acquired by the acquisition device CAM.

During a first part of a so-called landing phase of the aircraft AC, and following the detection of a terrestrial reference point in the step S40, the navigation system SYS implements the step S50. Within the meaning of the invention, the landing phase comprises both the approach by the aircraft AC to a runway and the landing of the aircraft AC on the runway.

During the step S50, the navigation module LOC_VISION determines navigation data OUT_LOC_VIS based on data from the inertial measurement unit IMU and from the sensor VISION. In particular, the navigation module LOC_VISION determines during the step S50 navigation data OUT_LOC_VIS using an observed position and a known position of the single terrestrial reference point AMER_1 detected in the captured images. Thus, during this part of the landing phase, the inertial navigation drift is offset based on a single terrestrial reference point.

During the step S60, the computer vision sensor VISION detects a plurality of terrestrial reference points AMER_2, AMER_3 (e.g. navigation lights in the vicinity of the runway, markings on the runway) in images captured by the capture device CAM.

During a second part of the landing phase of the aircraft AC, and following the detection of several terrestrial reference points in the step S60, the navigation system SYS implements the step S70.

During the step S70, the navigation module LOC_VISION determines navigation data OUT_LOC_VIS based on data from the inertial measurement unit IMU and from the sensor VISION. More precisely, the navigation data OUT_LOC_VIS are determined by the navigation module LOC_VISION based on the observed positions and on the known positions of the terrestrial reference points AMER_2 detected in the captured images. Thus, during this second part of the landing phase, the inertial navigation is recalibrated using a plurality of terrestrial reference points.

According to a particular embodiment, the navigation module LOC_VISION determines during the steps S50 and S70 of the navigation data OUT_LOC_VIS based on the differences ax, ay between relative observed and estimated positions of the terrestrial reference points AMER_1-AMER_3 with respect to said aircraft AC. This embodiment is described with reference to FIG. 1 and to the computer vision sensor VISION.

During the step S80, the navigation device APP detects the landing of the aircraft AC by way of a so-called Weight on Wheels switch.

During a so-called taxiing phase, and following the detection of the landing of the aircraft AC in the step S80, the navigation system SYS implements the step S90.

During the step S90, the navigation module LOC_VISION determines navigation data OUT_LOC_VIS based on data from the inertial measurement unit IMU and from the odometer ODOM. Thus, during this taxiing phase, the inertial navigation drift is offset based on the odometer data. Note that the navigation data determined during the taxiing phase are a function of navigation data determined during the preceding phases.

The proposed navigation solution allows to accurately determine the navigation data and thus to accurately guide the aircraft during the different phases of a flight, and to do so based on simple equipment.

The synergy between the different sensors used for the navigation allows to keep an accurate localization chain during the different phases (i.e. IMU-GPS, IMU, IMU-VISION with a landmark, IMU-VISION with several landmarks, and IMU-ODOM). In particular, the localization during the taxiing phase based on an odometer is even more accurate when images are used to recalibrate the inertial system during the landing phase. In other words, the use of landmarks during the landing phase in particular allows to accurately initialize the inertia-odometer hybrid navigation for the taxiing phase.

The proposed navigation solution and sequencing of the phases allow to capitalize on the respective advantages of the different sensors to obtain accurate navigation information. For each of the different phases, the proposed navigation solution relies on data transmitted by sensors that are accurate and reliable during this phase.

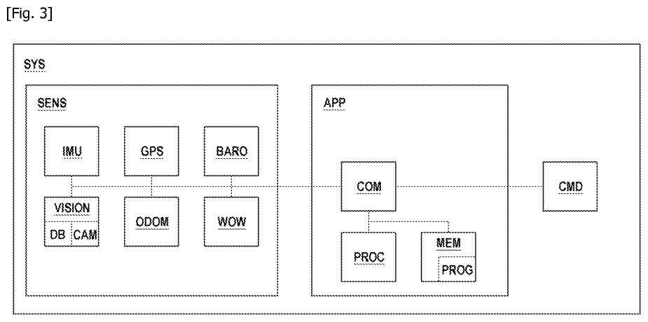

FIG. 3 schematically represents an example of a software and hardware architecture of a navigation system according to an embodiment of the invention.

As illustrated by FIG. 3, according to an embodiment, the proposed navigation device APP comprises: at least one processing unit or processor PROC; and at least one memory MEM.

The device APP has, according to an embodiment, the hardware architecture of a computer and includes, in this regard, a processor PROC, a random-access memory, a read-only memory MEM, and a non-volatile memory. The memory MEM associated with the device APP constitutes an information or recording medium in accordance with the invention, readable by a computer and by the processor PROC, on which is recorded a computer program PROG in accordance with the invention. The computer program PROG includes instructions for performing the steps of a method in accordance with the invention and implemented by the device APP, when the computer program PROG is executed by the processor PROC.

As illustrated by FIG. 3, according to an embodiment, the device APP has a communication module COM configured to communicate with at least one of the following elements: one or more sensors of the set of sensors SENS; and the guiding module CMD. Of course, no limitation is attached to the nature of the communication interfaces between the device APP and respectively: the sensors of the set SENS; and the guiding module CMD, which can be wired or wireless, and can implement any protocol known to those skilled in the art (Ethernet, Wi-Fi, Bluetooth, 3G, 4G, 5G, 6G, etc.).

According to an embodiment (not shown), the sensor VISION (also known as the computer vision device) has the hardware architecture of a computer and in this regard includes a processor PROC, a random-access memory, a read-only memory, and a non-volatile memory. In the embodiment described here, the memory associated with the sensor VISION constitutes an information medium, readable by a computer and on which is recorded a computer program. This computer program PROG includes instructions for performing the steps of a method in accordance with the invention and implemented by the sensor VISION, when this computer program is executed by a processor.

As illustrated by FIG. 3, according to an embodiment, the set of sensors SENS comprises: a Weight on Wheels switch configured to indicate whether or not the weight of the aircraft AC is resting on its wheels and, more specifically, to detect whether or not the aircraft AC has transitioned from a landing phase to a taxiing phase.

The term module may correspond just as well to a software component as to a hardware component or to a set of hardware and software components, a software component itself corresponding to one or more computer programs or sub-programs or more generally to any element of a program able to implement a function or a set of functions as described for the modules in question. Similarly, a hardware component corresponds to any element of a set of hardware able to implement a function or a set of functions for the module in question (integrated circuit, chip card, memory card, etc.)

Note that the order in which the steps of a method in accordance with the invention follow one another, particularly with reference to the attached drawings, constitutes only an exemplary embodiment devoid of any limitation, variants being possible. Moreover, the reference symbols are not limiting of the scope of the protection, their sole function being to simplify the understanding of the claims.

Those skilled in the art will understand that the embodiments and variants described above constitute only non-limiting exemplary implementations of the invention. In particular, those skilled in the art may envision any adaptation or combination of the embodiments and variants described above in order to meet a particular requirement.

1. A navigation method for an aircraft, wherein a first navigation module determines first navigation data of said aircraft, said method comprising:
during a landing phase of said aircraft, a step of determining said first navigation data based on data from an inertial measurement unit and from images captured by said aircraft; and
during a taxiing phase following the landing of said aircraft, a step of determining said first navigation data based on data from the inertial measurement unit and from at least one odometer,
said first navigation data determined during the taxiing phase being function of said first navigation data determined during the landing phase.

2. The method according to claim 1, wherein a second navigation module determines second navigation data, said method comprising:
during a flight phase of said aircraft preceding said landing phase, a step of determining said second navigation data based on data from the inertial measurement unit and from a satellite positioning module.

3. The method according to claim 2, comprising:
during a phase of descent of said aircraft following said flight phase and preceding said landing phase, a step of determining said first navigation data based on data from the inertial measurement unit and from an altimeter.

4. The method according to claim 2, wherein a control module provides to a guiding module of said aircraft:
during said flight phase of said aircraft, said second navigation data determined by the second navigation module; and
during said phases following said flight phase, said first navigation data determined by the first navigation module.

5. The method according to claim 1, comprising:
during a first part of said landing phase, a step of determining said first navigation data based on an observed position and on a known position of a single terrestrial reference point detected in said captured images; and
during a second part of said landing phase, a step of determining said first navigation data based on observed positions and on known positions of several terrestrial reference points detected in said captured images.

6. The method according to claim 1, comprising:
a step of detecting at least one terrestrial reference point in said captured images;
a step of determining an observed relative position of said at least one terrestrial reference point detected with respect to said aircraft based on said captured images; and
a step of determining an estimated relative position of said at least one terrestrial reference point detected with respect to said aircraft based on a position of said aircraft determined by the first navigation module and on a known position of said at least one terrestrial point
said first navigation data being determined by the first navigation module based on the difference between said observed and estimated relative positions of said at least one terrestrial reference point with respect to said aircraft.

7. The method according to claim 1, wherein at least one said navigation module comprises an inertial system and a Kalman filter to determine said navigation data.

8. A navigation device for an aircraft, said device comprising a first navigation module configured to determine first navigation data of said aircraft based on data from an inertial measurement unit, from at least one odometer and from images captured by said aircraft, the first navigation module being configured to:
during a landing phase of said aircraft, determine said first navigation data based on data from the inertial measurement unit and from the captured images; and
during a taxiing phase following the landing of said aircraft, determine said first navigation data based on data from the inertial measurement unit and from said at least one odometer,
said first navigation data determined during the taxiing phase being function of said first navigation data determined during the landing phase.

9. A navigation system for an aircraft said system comprising:
a navigation device according to claim 8;
an inertial measurement unit
an image capture device and
at least one odometer.

10. The navigation system according to claim 9, comprising a guiding module configured to guide said aircraft based on navigation data determined by said navigation device.

11. An aircraft comprising a navigation system according to claim 9.

12. A computer program comprising instructions for implementing the steps of a method according to claim 1, when said computer program is executed by at least one processor.

13. An information medium readable by a computer comprising a computer program according to claim 12.
